(19) United States
(12) Patent Application Publication
(10) Pub. No.: US 2005/0113496 A1
(43) Pub. Date: May 26, 2005

(54) Flame resistant polyamide resin composition containing phenolic resin and articles made therefrom

(76) Inventor: Yuji Saga, Tochigi (JP)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/953,682

(22) Filed: Sep. 29, 2004

Related U.S. Application Data
(60) Provisional application No. 60/508,540, filed on Oct. 3, 2003.

(51) Int. Cl. C08K 5/49

(52) U.S. Cl. 524/115

(57) ABSTRACT

The present invention relates to a flame resistant polyamide resin compositions for moulded articles and articles formed therefrom, comprising polyamide, phenolic resin, and a flame retardant comprising phosphinate and/or diphosphinate and, optionally, melamine derivatives. Further provided are articles for use in a variety of applications including electrical and electronic parts requiring electrical insulation.

### CROSS REFERENCE TO RELATED APPLICATIONS

This application claims priority of U.S. Provisional Application No. 60/508,540, filed Oct. 3, 2003.

### FIELD OF THE INVENTION

The present invention relates to certain flame resistant polyamide resin molding compositions employing a non-halogenated flame retardant. More particularly, the present invention relates to such polyamide resin molding compositions comprising selected phosphinates (and optionally also selected melamine products) as flame retardant, novolac, and inorganic reinforcing agents.

### BACKGROUND OF THE INVENTION

Polyamide resins possess excellent mechanical properties, moldability, and chemical resistance and have therefore been used in automotive parts, electric/electronic components, mechanical components, and many other applications. Articles made from polyamide resins possess extremely desirable physical properties. However, in certain applications, it is desirable that polyamide resin compositions be flame retardant and meet the UL-94 standard for a high degree of flame retardance. This requirement has promoted research into a variety of methods for imparting flame retardance to polyamide resins. A common method of imparting flame retardance to thermoplastic resin compositions involves incorporating a halogenated organic compound such as brominated polystyrene as a flame retardant along with an antimony compound that acts as a synergist for the flame retardant. However, the use of halogenated flame retardants has certain drawbacks in that these materials tend to decompose or degrade at the temperatures used to mold polyamide compositions. The degradation products can corrode the barrels of compounding extruders, the surfaces of molding machines, and other equipment halogenated flame retardants come in contact with at elevated temperatures. The degradation products of halogenated flame retardants can also result in molded articles that have poor surface appearance.

The use of non-halogenated flame retardants such as phosphate or phosphinate compounds with triazine derivatives has been proposed in WO 96/09344 but these flame retardants are unstable at high temperatures and can decompose or degrade during molding, leading to detrimental effects on the electrical properties of a compounded polyamide resin composition containing these flame retardants, especially under conditions of high humidity.

Thus, effective non-halogenated flame retardants that have good heat stability and that do not have a detrimental effect upon a resin's properties, in particular electrical properties, are desirable. For example, U.S. Pat. No. 6,255,371 discloses a flame retardant combination comprising polymers such as polyamide or polyester, phosphinate or diphosphinate, and condensation products of melamine and/or reaction products of melamine with phosphoric acid and/or reaction products of condensation products of melamine with phosphoric acid and/or a mixture of these. U.S. Pat. No. 5,773,556 discloses compositions comprising polyamide and phosphinic acid salt or a disphosphinic acid salt.

Based on the foregoing discussion, an object of the present invention is to provide a flame resistant polyamide resin composition capable of yielding articles that possess excellent flame retardance and good physical properties and good electrical insulation properties even under conditions of high humidity. A further object of the present invention is to provide shaped structures and parts that meet UL-94 standards for flame retardancy for use in electrical and electronic parts that require good electrical insulation properties. A feature of the present flame resistant polyamide resin compositions is their good heat stability in molding and attendant excellent moldability. An advantage of the present compositions is their notable mechanical properties. These and other objects, features and advantages of the present invention will become better understood upon having reference to the following description of the invention.

### SUMMARY OF THE INVENTION

The present invention, which allows the stated objective to be attained, concerns a flame retardant polyamide resin composition, comprising:
(a) about 20 to about 90 weight percent of (A) polyamide and (B) phenolic resin, wherein the ratio of (A) to (B) is between about 99:1 and about 40:60 by weight;
(b) about 5 to about 50 weight percent of (C) flame retardant comprising a phosphinate of the formula (I) and and/or a disphosphinate of the formula (II) and/or polymers of these 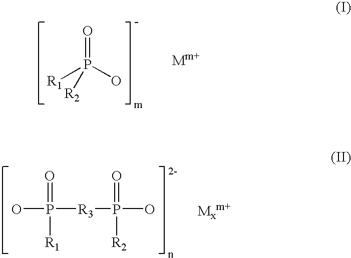
wherein R₁ and R₂ are identical or different and are C₁-C₆ alkyl, linear or branched, and/or aryl; R₃ is C₁-C₁₀-alkylene, linear or branched, C₆-C₁₀-arylene, -alkylarylene or -arylalkylene; M is calcium ions, magnesium ions, aluminum ions and/or zinc ions, m is 2 to 3; n is 1 or 3; x is 1 or 2; and
(c) 0 to about 50 weight percent of (D) inorganic reinforcing agent and/or filler,
   the above stated percentages being based on the total weight of the composition.

Further provided are articles made from the composition of the invention and more particularly such articles and compositions for use in electrical and electronic applications.

### DETAILED DESCRIPTION OF THE INVENTION

Polyamide

The polyamide used in the present invention may be a homopolymer, copolymer, terpolymer, or higher polymer. It may also be a blend of two or more polyamides. The polyamide may be aromatic or aliphatic. Aromatic polyamides are derived from monomers containing aromatic groups. Examples of monomers containing aromatic groups are terephthalic acid and its derivatives, isophthalic acid and its derivatives, and m-xylylenediamine.

The polyamide may be derived from adipic acid, sebacic acid, azelaic acid, dodecandoic acid, terephthalic acid, isophthalic acid or their derivatives and other aliphatic and aromatic dicarboxylic acids and aliphatic alkylenediamines, aromatic diamines, and/or alicyclic diamines. Preferred diamines include hexamethylenediamine, 2-methylpentamethylenediamine, 1,9-diaminononane, 1,10-diaminodecane, and 1,12-diaminododecane. It may also be derived from lactams or aminoacids.

Examples of suitable aliphatic polyamides are polyamides 6, 66, 46, 610, 69, 612, 10, 10, 11, 12. Preferred aromatic polyamides include poly(m-xylylene adipamide) (polyamide MXD,6); poly(docemethylene terephthalamide) (polyamide 12,T); poly(decaamethylene terephthalamide) (polyamide 10,T); poly(nonamethylene terephthalamide) (polyamide 9,T); the polyamide of hexamethylene terephthalamide and hexamethylene adipamide (polyamide 6,T/6,6); the polyamide of hexamethyleneterephthalamide and 2-methylpentamethyleneterephthalamide (polyamide 6,T/D,T); the polyamide of hexamethylene terephthalamide and hexamethylene isophthalamide (polyamide 6,T/6,I) and copolymers and mixtures of these polymers. Aromatic monomers will preferably comprise at least 10 mole percent of the dicarboxylic acid monomers used to make preferred aromatic polyamides used in the present invention. Preferred aromatic monomers are terephthalic acid and its derivatives and isophthalic acid and its derivatives.

Examples of aliphatic polyamide copolymers or aliphatic polyamide terpolymers include polyamide 66/6 copolymers, polyamide 66/68 copolymers, polyamide 66/610 copolymers, polyamide 66/612 copolymers, polyamide 66/10 copolymers, polyamide 66/12 copolymers, polyamide 6/68 copolymers, polyamide 6/610 copolymers, polyamide 6/612 copolymers, polyamide 6/10 copolymers, polyamide 6/12 copolymers, polyamide Jun. 66, 19610 terpolymers, polyamide Jun. 66, 1969 terpolymers, polyamide 6/66/11 terpolymers, polyamide 6/66/12 terpolymers, polyamide 6/610/11 terpolymers, polyamide 6/610/12 terpolymers, and polyamide 6/66/PACM [where PACM refers to bis-p-(aminocyclohexyl)methane)] terpolymers.

Of these, polyamide 66/6 copolymers, polyamide Jun. 66, 19610 terpolymers, polyamide Jun. 66, 19612 terpolymers, and mixtures of two or more of these polymers are preferred. Especially preferred are polyamide 66/6 copolymers in which the molar ratio of polyamide 66 units to polyamide 6 units ranges from 98:2 to 2:98; polyamide Jun. 66, 19610 terpolymers in which the ratio of the moles of polyamide 6 units and polyamide 66 units combined to the moles of polyamide 610 units is from 98:2 to 25:75, and the molar ratio of polyamide 6 units to polyamide 66 units is from 2:98 to 98:2; and polyamide Jun. 66, 19612 terpolymers in which the ratio of the moles of polyamide 6 units and polyamide 66 units combined to the moles of polyamide 612 units is from 98:2 to 25:75, and the molar ratio of polyamide 6 units to polyamide 66 units is from 2:98 to 98:2.

Polyamides 66, 11, 12, 6/10, 6/12, and 10/10 are especially advantageous for use in molding articles for uses in applications that require good barrier properties to the permeation of fluid (both liquid and gaseous) fuel materials as well as good mechanical properties, moldability, and chemical resistance properties.

The polyamides used in the present invention may also be blended with other thermoplastic polymers such as ABS (acrylonitrile/butadiene/styrene terpolymers), polypropylene, poly(ethylene oxide), polyether ester amides, ionomers, polystyrene, polycarbonate, styrene maleimide copolymer, and AES.

Phenolic Resin

The phenolic resin used in the present invention is not restricted in so far as it can be used in a resin for conventional plastic moldings and may be either a thermoplastic novolac or resol or a blend of two or more novolacs, two or more resols, or at least one novolac and at least one resol. Preferred are novolacs, also known as thermoplastic phenol-formaldehyde resins, that are prepared by reacting at least one aldehyde with at least one phenol or substituted phenol in the presence of an acid or other catalyst such that there is a molar excess of the phenol or substituted phenol. Suitable phenols and substituted phenols include phenol, o-cresol, m-cresol, p-cresol, thymol, p-butyl phenol, tert-butyl catechol, resorcinol, bisphenol A, isoeugenol, o-methoxy phenol, 4,4′-dihydroxyphenyl-2,2-propane, isoamyl salicylate, benzyl salicylate, methyl salicylate, 2,6-di-tert-butyl-p-cresol, and the like. Suitable aldehydes and aldehyde precusors include formaldehyde, paraformaldehyde, polyoxymethylene, trioxane, and the like. More than one aldehyde and/or phenol may be used in the preparation of the novolac. A blend of two more different novolacs may also be used. Any novolac that can be used for conventional plastic molding is suitable, although a number average molecular weight of between 500 and 1500 will provide minimal warpage and optimal mechanical properties.

The phenolic resin can act as a char former when the compositions of the present invention are burned and reduces the amount of moisture that is absorbed by the compositions.

The total amount of polyamide and phenolic resin used in the composition of the present invention is about 20 to about 90 weight percent, based on the total weight of the composition. The ratio of polyamide to novolac by weight is between about 99:1 and about 40:60, or preferably between about 98:2 and about 50:50, or more preferably between about 97:3 and about 60:40.

Flame Retardant

The flame retardants in the polyamide resin composition in this invention are flame retardant combinations (such as those disclosed in U.S. Pat. No. 6,255,371) comprising (a), a phosphinate of the formula (I) and/or a diphosphinate of the formula (II) and/or polymers of these, 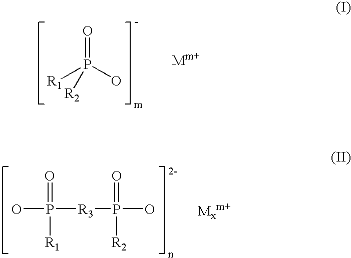
wherein R₁ and R₂ are identical or different and are C₁-C₆ alkyl, linear, or branched, and/or aryl; R₃ is C₁-C₁₀-alkylene, linear, or branched, C₆-C₁₀-arylene, -alkylarylene or -arylalkylene; M is calcium ions, magnesium ions, aluminum ions and/or zinc ions; m is 2 to 3; n is 1 or 3; and x is 1 or 2; and optionally comprising, condensation products of melamine and/or reaction products of melamine with phosphoric acid and/or reaction products of condensation products of melamine with phosphoric acid and/or comprising a mixture of these.

R₁ and R₂ may be identical or different and are preferably methyl, ethyl, n-propyl, isopropyl, n-butyl, tert-butyl, n-pentyl and/or phenyl. R₃ is preferably methylene, ethylene, n-propylene, isopropylene, n-butylene, tert-butylene, n-pentylene, n-octylene, n-dodecylene, or phenylene or naphthylene, or methylphenylene, ethylphenylene, tert-butylphenylene, methylnaphthylene, ethylnaphthylene or tert-butylnaphthylene, or phenylmethylene, phenylethylene, phenylpropylene or phenylbutylene. M is preferably aluminum ions or zinc ions.

Preferred phosphinates are aluminum diethylphosphinate and aluminum methylethylphosphinate.

The flame retardant may optionally further comprise condensation products of melamine and/or reaction products of melamine with phosphoric acid and/or reaction products of condensation products of melamine with phosphoric acid and/or a mixture of these (where the foregoing are collectively referred to as “melamine derivatives”). Examples of condensation products of melamine are preferably melem, melam, melon and/or more highly condensed compounds thereof. Preferred reaction products of melamine with phosphoric acid and/or reaction products of condensation products of melamine with phosphoric acid are melamine pyrophosphate, dimelamine pyrophosphate, melamine polyphosphate, melem polyphosphate, melam polyphosphate and/or mixed polysalts of this type.

Particularly preferred reaction products of melamine with phosphoric acid are melamine polyphosphates having chain lengths >2, and in particular >10.

The composition of the present invention contains about 5 to about 50 weight percent, or preferably about 10 to about 40 weight percent of the above flame retardants, each of the above percentages being based on the total of the composition. When melamine derivatives are present, the ratio by weight of phosphinate and/or diphosphinate to melamine derivatives will be preferably between about 95:5 and 30:70, or more preferably between about 90:10 and 40:60, or yet more preferably between about 80:20 and 50:50.

Other flame retardant synergists may also be optionally included in the composition in conventional amounts and as understood by those having skill in the field. Examples include silicone, metal oxides such as silica, aluminum oxide, iron oxide, titanium oxide, manganese oxide, magnesium oxide, zirconium oxide, zinc oxide, molybdenum oxide, cobalt oxide, bismuth oxide, chromium oxide, tin oxide, antimony oxide, nickel oxide, copper oxide and tungsten oxide, metal powder such as aluminum, iron, titanium, manganese, zinc, molybdenum, cobalt, bismuth, chromium, tin, antimony, nickel, copper and tungsten, and metal salts such as zinc borate, zinc metaborate, barium metaborate, zinc carbonate, magnesium carbonate, calcium carbonate, and barium carbonate,

Inorganic Reinforcing Agent and/or Filler

The inorganic reinforcing agent and/or filler of the present invention are those customarily used in the reinforcement and filling of engineering polymers. Mixtures of two or more inorganic fillers and/or reinforcing agents may be used. Examples of inorganic reinforcing agents and/or fillers include one or more of glass fibers, glass flakes, kaolin, clay, talc, wollastonite, calcium carbonate, silica, carbon fibers, potassium titanate, etc. Glass fibers are preferred. The inorganic reinforcing agent and/or filler used in the present invention is present in up to about 60 weight percent, or, preferably, in about 5 to about 50 weight percent, based on the total weight of the composition.

The polyamide resin compositions of the present invention may further contain other polymers, impact modifiers, organic fillers, heat stabilizers, plasticizers, antioxidants, nucleating agents, dyes, pigments, mold-release agents, lubricants, flame retardants, impact modifiers, and other additives in addition to the components mentioned previously. Examples of antioxidants include phenolic antioxidants, thioether antioxidants, and phosphite antioxidants.

The polyamide resin compositions of the present invention are melt-blended and can be manufactured by any known manufacturing methods. The component materials may be mixed to homogeneity using a melt-mixer such as a single or twin-screw extruder, blender, kneader, Banbury mixer, etc. to give a resin composition. Or, part of the materials may be mixed in a melt-mixer, and the rest of the materials may then be added and further melt-mixed until homogeneous.

The articles of the present invention may be formed from the composition of the invention by any known means such as injection molding, blow molding, extrusion, or thermoforming. Examples of articles that may be formed from the compositions of the present invention are housings, electrical connectors and connector housings and cases, breaker housings, and contactor housings.

The invention is illustrated by the following Examples.

### EXAMPLES

### Example 1 and Comparative Example 1

The components were dry blended and then compounded at a temperature of 295° C. and a screw speed of 200 rpm using a ZSK40 twin-screw extruder manufactured by W&P. Upon exiting the extruder, the molten polymer was quenched in a water bath and palletized.

The resultant resin compositions were used to mold 13 mm×130 mm×3.2 mm test pieces according to ASTM D638. The following test procedures were used:
Surface Surface resistivity of test specimens after conditioning at
resistivity: 60 □ and 100% relative humidity for 240 hours was measured by a Mitsubishii Yuka Hiresta resistivity meter.
Mold deposit: The mold surface was visually checked after 30 0.8 mm thickness UL bars were molded in a Toshiba IS170F3 molding machine with a melt temperature of 290° C. and a mold temperature of 80° C. If mold deposit was seen on the surface of the mold, this is indicated in Tables 1 and 2.
Flex strain at Measured strain at break of 0.8 mm thickness test
break: specimens using ASTM D790.
Swelling in 127×76×3.2 mm plates were conditioned at 60° C. and
TD/MD: 100% relative humidity for 220 hours. The percentage change in the dimensions of the plate in the machine direction (MD) and transverse direction (TD) after conditioning were determined.
TE: Tensile elongation at break of specimens measured dry-as-molded following ISO 527-1/2.
TE after 500 h at Tensile elongation at break of specimens conditioned 130° C.: at '130° C. for 500 hours and measuring following ISO 527-1/2.
   Flame resistance testing was done according to UL-94 (20 mm Vertical Burning Test) using 1/32nd inch (referred to in the table as 0.8 mm) thick test pieces which are then conditioned for either 48 hours at 23° C. and 50% relative humidity or 168 hours at 70° C.

The components shown in Table 1 were as follows:

TABLE 1

| | Example 1 | Comp. Exp. 1 |
|---|---|---|
| Polyamide 66 | 47 | 56 |
| Flame retardant | 20 | 24 |
| Novolac resin | 10 | — |
| Glass fiber | 23 | 20 |
| Total | 100 | 100 |
| Mold deposit | No | No |
| Surface resistivity | 3.E+07 | 3.E+05 |
| (ohm) | | |
| Swelling in TD/MD (%) | 0.75/0.30 | 0.99/0.39 |
| UL94 (0.8 mm) | V-0 | V-0 |
| Flex strain at break (%) | 1.9 | 3.4 |
| TE initial (%) | 2.1 | 2.5 |
| TE after 500 h at 130° C. | 1.6 | 1.6 |
| (%) | | |

Polyamide 66: Polyamide 66 (Zytel ® FE1111, manufactured by DuPont)
Flame retardant: Exolit OP1312 available from Clariant.
Novolac resin: Phenolite ® TD2091 (available from Dainippon Ink & Chemicals)
Glass fibers FT756X (Asahi Fiber Glass)

Ingredient amounts are given in weight percent relative to the total weight of the composition.

It can thus be seen that the polyamide resin composition of the present invention is a resin composition which possesses excellent flame retardance and good mechanical properties and exhibits superb electrical insulation properties even when under high humidity conditions. In addition, the compositions can be molded without generating significant mold deposit.

1. A flame retardant polyamide resin composition, comprising:
(a) about 20 to about 90 weight percent of (A) polyamide and (B) phenolic resin, wherein the ratio of (A) to (B) is between about 99:1 and about 40:60 by weight;
(b) about 5 to about 50 weight percent of (C) flame retardant comprising a phosphinate of the formula (I) and and/or a disphosphinate of the formula (II) and/or polymers of these 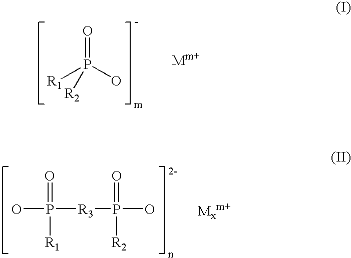
wherein R₁ and R₂ are identical or different and are C₁-C₆ alkyl, linear or branched, and/or aryl; R₃ is C₁-C₁₀-alkylene, linear or branched, C₆-C₁₀-arylene, -alkylarylene or -arylalkylene; M is calcium ions, magnesium ions, aluminum ions and/or zinc ions, m is 2 to 3; n is 1 or 3; x is 1 or 2; and
(c) 0 to about 60 weight percent of (D) inorganic reinforcing agent and/or filler,
the above stated percentages being based on the total weight of the composition.

2. The flame retardant polyamide resin composition of claim 1, wherein flame retardant (C) further comprises condensation products of melamine and/or reaction products of melamine with phosphoric acid and/or reaction products of condensation products of melamine with phosphoric acid and/or a mixture of these.

3. The flame retardant polyamide resin composition of claim 1, wherein the phenolic resin is novolac.

4. The flame retardant polyamide resin composition of 1, wherein the inorganic reinforcing agent is present in about 5 to about 50 weight percent.

5. The flame retardant polyamide resin composition of claim 1, further comprising one or more antioxidants.

6. The flame retardant polyamide resin composition of claim 2, further comprising one or more antioxidants.

7. The flame retardant polyamide resin composition of claim 5, wherein the one ore more antioxidants are selected from one or more of phenolic antioxidants, thioether antioxidants, and phosphite antioxidants.

8. The flame retardant polyamide resin composition of claim 6, wherein the one ore more antioxidants are selected from one or more of phenolic antioxidants, thioether antioxidants, and phosphite antioxidants.

9. The flame retardant polyamide resin composition of claim 1, wherein the inorganic reinforcing agent and/or filler is glass fibers.

10. The flame retardant polyamide resin composition of claim 2, wherein the inorganic reinforcing agent and/or filler is glass fibers.

11. The flame retardant polyamide resin composition of claim 1 wherein the flame retardant (c) comprises aluminum diethylphosphinate and/or aluminum methylethylphosphinate.

12. The flame retardant polyamide resin composition of claim 2 wherein the flame retardant (c) comprises aluminum diethylphosphinate and/or aluminum methylethylphosphinate.

13. A molded article comprising the flame resistant polyamide resin composition of any one of claims 1-12.
